(19) United States
(12) Patent Application Publication
(10) Pub. No.: US 2019/0385262 A1
(43) Pub. Date: Dec. 19, 2019

(54) INFORMATION PROCESSING METHOD AND INFORMATION PROCESSING DEVICE

(71) Applicant: TOYOTA JIDOSHA KABUSHIKI KAISHA, Toyota-shi (JP)

(72) Inventor: Masahiro Kuwahara, Kasukabe-shi (JP)

(73) Assignee: TOYOTA JIDOSHA KABUSHIKI KAISHA, Toyota-shi (JP)

(21) Appl. No.: 16/433,123

(22) Filed: Jun. 6, 2019

(30) Foreign Application Priority Data
Jun. 14, 2018 (JP) 2018-113688

(51) Int. Cl. G06Q 50/28; G06Q 10/06

(52) U.S. Cl. CPC G06Q 50/28; G01C 21/3423; G06Q 10/06314; G06Q 10/06315

(57) ABSTRACT

An information processing method for determining candidate locations for setting an embarkation/disembarkation point of a transportation mode that is operatable on-demand, the method comprises; dividing the subject area into a plurality of unit zones; calculating, for each of the plurality of unit zones, a first index, which is a cost index of a case in which travel is performed using the first transportation mode, a second index, which is a cost index of a case in which travel is performed using the second transportation mode, and a third index, which is a difference between the first index and the second index, the travel being performed using the unit zone as a start point; and extracting unit zones constituting candidates for setting an embarkation/disembarkation point of the second transportation mode from the plurality of unit zones on the basis of the third index calculated for each of the plurality of zones.

### CROSS REFERENCE TO THE RELATED APPLICATION

This application claims a priority of Japanese Patent Application No. 2018-113688, filed on Jun. 14, 2018, which is hereby incorporated by reference herein in its entirety.

### BACKGROUND

### Technical Field

The present invention relates to a transportation mode that is operatable on-demand.

### Description of the Related Art

In recent years, transportation modes that is operatable on-demand have come to attention as a means for complementing public transportation in areas deficient therein. A transportation mode that is operatable on-demand is a transportation mode that is operatable in accordance with the needs of users, and examples thereof include car-sharing and on-demand buses. It is believed that as self-driving vehicles become more widespread, the importance of transportation modes that is operatable on-demand will increase.

One of the problems that arises when newly establishing a transportation mode that is operatable on-demand is where to provide embarkation/disembarkation points (embarkation/disembarkation stations and the like).

An estimation method based on previous records may be employed as one of methods for estimating embarkation/disembarkation points that users wish to use. Japanese Patent Application Publication No. 2017-204168, for example, describes a method for estimating taxi demand using facility information. With this method, it is possible to specify geographical locations forecast to be used by large numbers of users.

### SUMMARY

However, when estimation is performed on the basis of previous records, a problem occurs in that geographical locations (railway stations, commercial facilities, and so on, for example) where larger numbers of people gather are extracted preferentially, making it impossible to extract embarkation/disembarkation points that can be used to complement public transportation.

For example, even if there are areas that are deficient in public transportation and would be greatly improved in convenience by newly establishing an on-demand transportation mode therein, it is impossible to ascertain where these areas are with a conventional method.

The present invention has been designed in consideration of the problem described above, and an object thereof is to determine suitable embarkation/disembarkation points for an on-demand transportation mode.

The present invention in its one aspect provides an information processing method for determining candidate locations for setting an embarkation/disembarkation point of a second transportation mode that is operatable on-demand, using as a subject an area in which a first transportation mode having a managed operation schedule and the second transportation mode are both available.

The first transportation mode is a transportation mode having a predetermined operating schedule, such as a train or a bus. The second transportation mode, meanwhile, is a transportation mode that is operatable in accordance with the needs of a user, such as a car-sharing scheme, an on-demand bus, or an on-demand shared taxi, for example. When establishing a transportation mode of this type, which is operatable on-demand, it is necessary to provide embarkation/disembarkation points (embarkation/disembarkation stations, stops, and so on) that are convenient for a large number of people. The present invention includes a method for specifying suitable embarkation/disembarkation points for a transportation mode that is operatable on-demand.

The method comprising a division step for dividing the subject area into a plurality of unit zones; a calculation step for calculating, for each of the plurality of unit zones, a first index, which is a cost index of a case in which travel is performed using the first transportation mode, a second index, which is a cost index of a case in which travel is performed using the second transportation mode, and a third index, which is a difference between the first index and the second index, the travel being performed using the unit zone as a start point; and an extraction step for extracting unit zones constituting candidates for setting an embarkation/disembarkation point of the second transportation mode from the plurality of unit zones on the basis of the third index calculated for each of the plurality of zones.

In the division step, the subject area is divided into a plurality of unit zones. The unit zones can be set on a 100 m square grid, for example, although there are no particular limitations on the shape and size thereof.

In the calculation step, the first index and the second index, as well as the third index, which is the difference therebetween, are calculated for all of the unit zones. The first index is a cost index in a case where travel is performed using only the first transportation mode, and the second index is a cost index in a case where travel is performed using only the second transportation mode. The cost index may be the “total travel time”, the “travel fee”, the “ride time”, the “walking time”, the “number of changes”, and so on, for example, but is not limited thereto. The cost index may also be a combination of a plurality of indices. When the cost index is a combination of a plurality of indices, the third index is a combination of the differences between the respective indices. By executing the calculation step, the advantageousness of using the second transportation mode can be acquired for each unit zone.

In the extraction step, unit zones serving as candidates for setting an embarkation/disembarkation point of the second transportation mode are extracted on the basis of the third index. For example, the candidates are extracted on the basis of the magnitude of the third index and the type of the cost index.

According to this configuration, candidates for embarkation/disembarkation points of the second transportation mode can be determined using the cost improvement as an index.

Further, the first index and the second index may be each constituted by a representative value of a plurality of cost indices of cases in which travel is performed from a subject unit zone to each of the remaining plurality of unit zones.

When calculating the cost index with respect to a certain unit zone, it is preferable to determine a representative value of a plurality of cost indices acquired in cases where the unit zone is set as the departure point and the remaining plurality of unit zones are each set as the arrival point. For example, after acquiring all of the cost indices in cases where all of the other unit zones are set as the arrival point, the average, the median, the mode, or another value of the plurality of acquired cost indices is determined and set as the representative value. As a result, the cost improvement realized when a certain unit zone is set as the departure point of the second transportation mode can be calculated.

Further, in the extraction step, the unit zones constituting the candidates for setting an embarkation/disembarkation point of the second transportation mode may be extracted from unit zones in which the third index satisfies a predetermined condition.

The predetermined condition may be the improvement in the cost index or the like, for example. Further, a plurality of conditions may be provided for each type of cost index.

Further, in the calculation step, a plurality of third indices may be calculated for each unit zone using different cost indices, and in the extraction step, the unit zones constituting the candidates for setting an embarkation/disembarkation point of the second transportation mode may be extracted from unit zones in which the plurality of third indices satisfy predetermined conditions.

Hence, the third index may be calculated using different cost indices, such as the “walking distance” and the “total travel time”, for example. According to this configuration, embarkation/disembarkation point candidates can be determined using different viewpoints, and as a result, the advantageousness can be determined in a more comprehensive manner.

Further, the method may further comprise a travel demand acquisition step for acquiring a travel demand between the unit zones, and an assigning step for assigning rankings to the extracted unit zones on the basis of the travel demand.

The travel demand may take the form of previous travel records over a predetermined period in the past, for example. Alternatively, the travel demand may take an OD format (a format expressed by pairs of departure points and arrival points (Origin/Destination format)), for example. By assigning rankings on the basis of the actual travel demand, unit zones that are more suitable for setting an embarkation/disembarkation point of the second transportation mode can be extracted from the plurality of unit zones.

Further, in the assigning step, the plurality of unit zones may be classified into a plurality of groups on the basis of the plurality of third indices, and the rankings may be assigned to each of the groups.

Further, in the assigning step, the rankings may be assigned using a different reference for each group.

According to this configuration, the unit zones can be extracted in relation to each of a plurality of viewpoints, such as a group corresponding to the viewpoint of “time reduction” and a group corresponding to the viewpoint of “fee reduction”, for example. Note that the respective groups may also be ranked using different references. As a result, appropriate rankings can be assigned in accordance with the viewpoint.

Note that the present invention can be specified as an information processing method including at least a part of the means described above. The present invention can also be specified as a program for causing a computer to execute the information processing method and an information processing device for implementing the information processing method. The processing and means described above may be implemented in any desired combinations, providing that no technical contradictions arise as a result.

According to the present invention, it is possible to determine suitable embarkation/disembarkation points for an on-demand transportation mode.

### BRIEF DESCRIPTION OF THE DRAWINGS

FIG. 1 is a view showing a hardware configuration of an operation planning device 10 according to a first embodiment;

FIG. 2 is a view showing a module configuration of the operation planning device 10 according to the first embodiment;

FIG. 3 is a view illustrating a method for dividing a subject area according to the first embodiment;

FIG. 4 is a view illustrating travel between zones;

FIG. 5 is a flowchart showing processing executed by the operation planning device 10 according to the first embodiment;

FIG. 6 is a flowchart showing in detail processing for calculating indices;

FIGS. 7A and 7B are views illustrating the calculated indices;

FIG. 8 is a view illustrating representative values of a third index;

FIG. 9 is a view illustrating processing for extracting candidate zones for setting stations;

FIG. 10 is a view showing a module configuration of the operation planning device 10 according to a second embodiment; and

FIG. 11 is a flowchart showing processing executed by the operation planning device 10 according to the second embodiment.

### DESCRIPTION OF THE EMBODIMENTS

### First Embodiment

Preferred embodiments of the present invention will be described below with reference to the figures.

An operation planning device according to this embodiment is a device for determining where to set stations of an on-demand transportation mode (referred to hereafter as on-demand transportation). On-demand transportation typically refers to a one-way drop-off type car-sharing service (including a mobility service) or the like, but may refer to any transportation mode that is operatable in accordance with the needs of the user and is not particularly limited thereto.

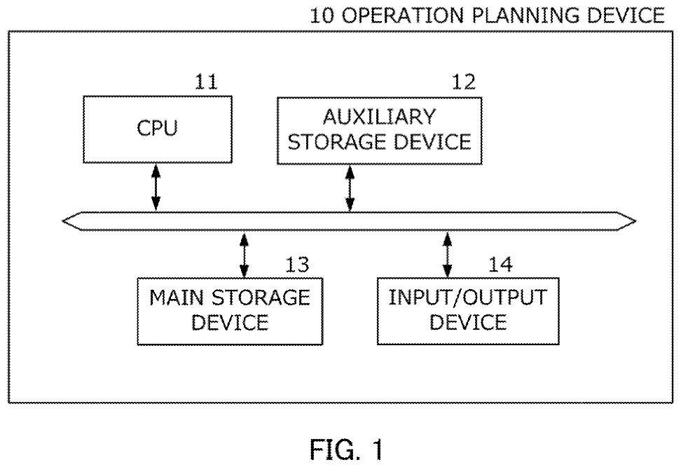

FIG. 1 is a view showing a hardware configuration of an operation planning device 10 according to this embodiment. The operation planning device 10 is a device for determining suitable setting locations for on-demand transportation embarkation/disembarkation stations (referred to simply as stations hereafter) on the basis of information relating to transportation in a subject area, actual travel demand, and so on. The operation planning device 10 is a small computer such as a personal computer, a smartphone, a tablet computer, a personal information terminal, a laptop computer, or a wearable computer (a smart watch or the like), for example. The operation planning device 10 is configured to include a central processing unit (CPU) 11, an auxiliary storage device 12, a main storage device 13, and an input/output device 14.

The CPU 11 is a calculation device for administering control executed by the operation planning device 10.

The auxiliary storage device 12 is a rewritable nonvolatile memory. Programs executed by the CPU 11 and data used by these control programs are stored in the auxiliary storage device 12. The auxiliary storage device 12 may store the programs executed by the CPU 11 so as to be packaged as applications. The auxiliary storage device 12 may also store an operating system for executing these applications.

The main storage device 13 is a memory in which the programs executed by the CPU 11 and the data used by the control programs are expanded. When a program stored in the auxiliary storage device 12 is loaded to the main storage device 13 and executed by the CPU 11, the processing to be described below is implemented.

The input/output device 14 serves as a means for inputting and outputting data. The input/output device 14 is typically configured to include a keyboard or a mouse, a display device, and so on, but may include other components. In this embodiment, information relating to transportation in the subject area and information relating to the actual travel demand (previous travel records) are acquired as input data, and positions serving as candidates for setting stations are output. Note that the input/output device 14 may either receive input of the information from the user of the device or acquire the information from a storage medium or a network. For this purpose, the input/output device 14 may include a drive device, a network interface, and so on.

Note that the configuration shown in FIG. 1 is an example, and all or some of the functions shown in the figure may be executed using dedicated circuits. Further, program storage and execution may be performed using a combination of a main storage device and an auxiliary storage device other than those illustrated in the figure.

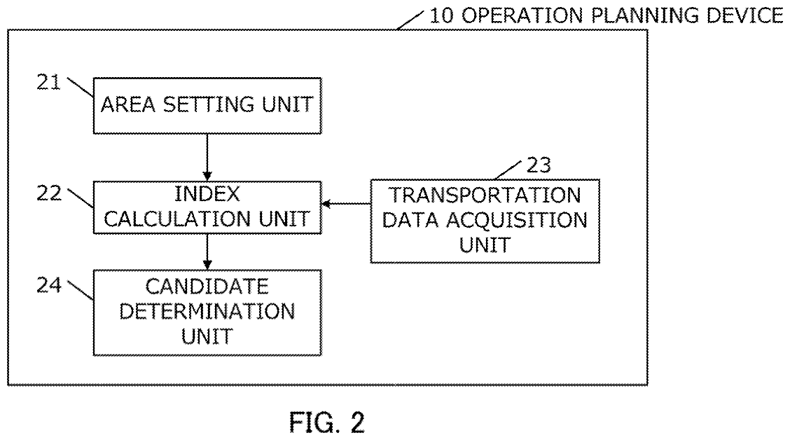

Next, an outline of the processing performed by the operation planning device 10 will be described with reference to FIG. 2, which is a view showing the processing executed by the CPU 11 of the operation planning device 10 in the form of function blocks.

An area setting unit 21 sets information relating to the subject area to be examined. The area setting unit 21 stores information (map data, for example) relating to settable areas, provides this information to the user, and determines the subject area on the basis of an instruction acquired from the user. The area setting unit 21 displays map data in the form of a graphic using the input/output device 14, for example, and sets a region specified by a pointer as the subject area.

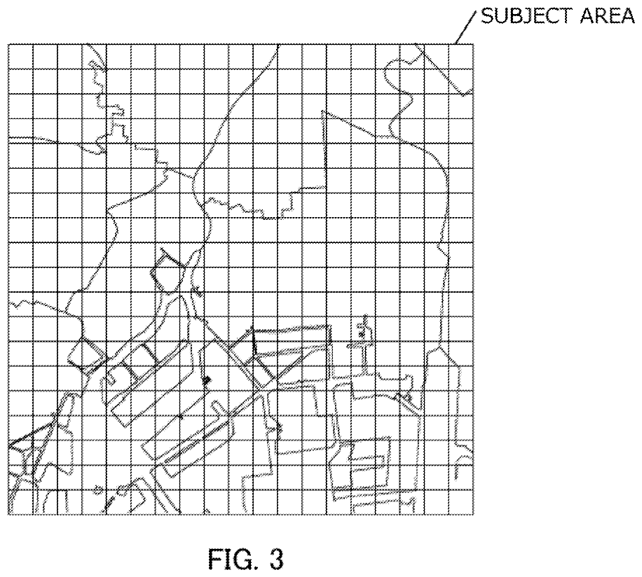

FIG. 3 is a view showing the set subject area. In this embodiment, as shown in the figure, the subject area is divided by a grid, and processing is performed using divided zones as minimum units. In this example, the subject area is divided into squares of 250 square meters, but the size into which the subject area is divided is not limited thereto. Moreover, the subject area may be divided into shapes other than squares. Note that in the following description, the unit zones acquired from the division will be referred to simply as “zones”.

An index calculation unit 22 serves as a means for calculating a cost index (referred to hereafter simply as an index) of a case in which a transportation user (referred to hereafter as a consumer) travels between zones. In this embodiment, the index calculation unit 22 calculates an index (a first index) of a case in which only public transportation is used and an index (a second index) of a case in which only on-demand transportation is used.

Examples of indices used to evaluate transportation modes include the “fee”, the “total travel time”, the “ride time”, the “walking time”, the “walking distance”, the “number of changes”, and so on, but other indices that can be considered as the travel cost may also be used. In this embodiment, the index calculation unit 22 is capable of calculating a plurality of indices as both the first index and the second index.

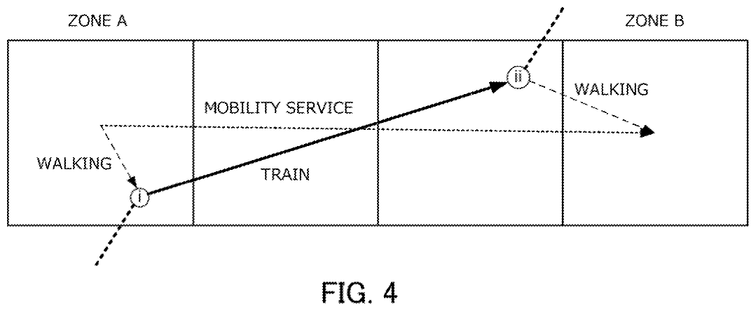

Here, an example of index calculation will be described, using travel from zone A to zone B in FIG. 4 as an example. In this case, a pattern in which only a one-way drop-off type mobility service, which serves as an on-demand transportation mode, is used will be referred to as pattern 1, and a pattern in which only public transportation is used will be referred to as pattern 2. Note that here, it is assumed that the departure and arrival points of the consumer correspond to the center points of the respective zones and that stations of the mobility service are likewise located in the centers of the respective zones.

In the case of pattern 1, when a station is provided in zone A, the consumer can embark and start to travel immediately. In the case of pattern 2, on the other hand, the consumer walks to train station i, boards the train, travels to train station ii, and then walks to zone B. Examples of the indices will be described below.

<When Total Travel Time is Used as Index>

Pattern 1: The travel time of the mobility service

Pattern 2: The walking time to train station i+the travel time on the train+the walking time from train station ii

### <When Fee is Used as Index>

Pattern 1: The fee for using the mobility service

Pattern 2: The train fare from train station i to train station ii

### <When Walking Distance (Total Distance Covered on Foot) is Used as Index>

Pattern 1: 0

Pattern 2: The distance from the center point of zone A to train station i+the distance from train station ii to the center point of zone B

Thus, the index calculation unit 22 calculates a plurality of indices relating to travel between the zones for each transportation mode. A specific method will be described below.

A transportation data acquisition unit 23 serves as a means for acquiring transportation-related data that are used by the index calculation unit 22. For example, in response to a request from the index calculation unit 22, the transportation data acquisition unit 23 calculates a route on which to travel between specified zones using public transportation and provides data (the distance, the number of changes, the fee, and so on, for example) relating to the route. Further, the transportation data acquisition unit 23 calculates a route on which to travel between the specified zones using the mobility service and provides data (the distance, the fee, and so on, for example) relating to the route.

Note that data stored in advance may be used as the transportation-related data. Alternatively, the transportation-related data may be acquired from a network or the like.

A candidate determination unit 24 determines suitable zones for setting stations on the basis of the indices calculated by the index calculation unit 22 and outputs corresponding candidates.

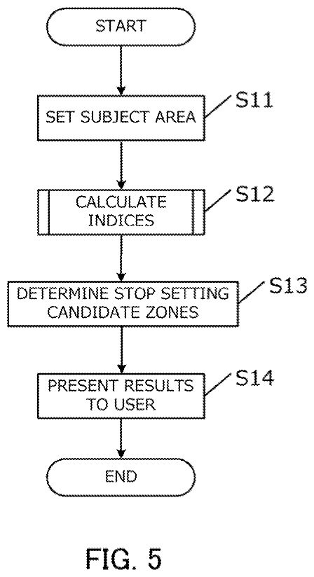

Next, the processing performed by the respective modules will be described in further detail. FIG. 5 is a flowchart showing a flow of the processing executed by the operation planning device 10.

First, in step S11, the area setting unit 21 sets the subject area. The subject area may be specified by the user of the device through the input/output device 14. For example, map data acquired and stored in advance may be presented to the user to prompt the user to specify the subject area. The subject area may be specified using a pointing device or the like or by inputting the name of an administrative district or the like. The set subject area is divided into a plurality of predetermined zones, as shown in FIG. 3.

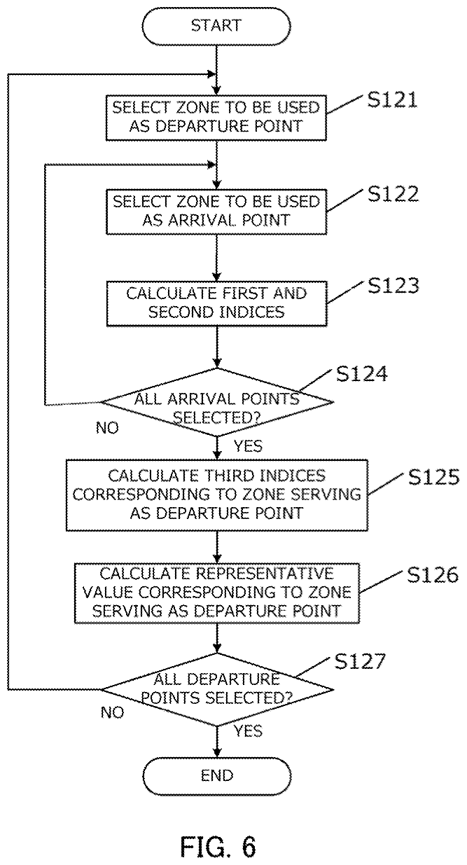

Next, in step S12, the index calculation unit 22 calculates the indices using the plurality of divided zones as subjects. The processing for calculating the indices will now be described in detail. FIG. 6 is a flowchart showing the processing of step S12 in detail.

First, in step S121, a single zone to be set provisionally as the departure point is selected from the plurality of zones included in the subject area. Next, in step S122, a single zone to be set provisionally as the arrival point is selected. Then, in step S123, the indices (the first index) of a case in which travel is performed from the selected departure point to the selected arrival point using only public transportation and the indices (the second index) of a case in which travel is performed from the selected departure point to the selected arrival point using only on-demand transportation are calculated.

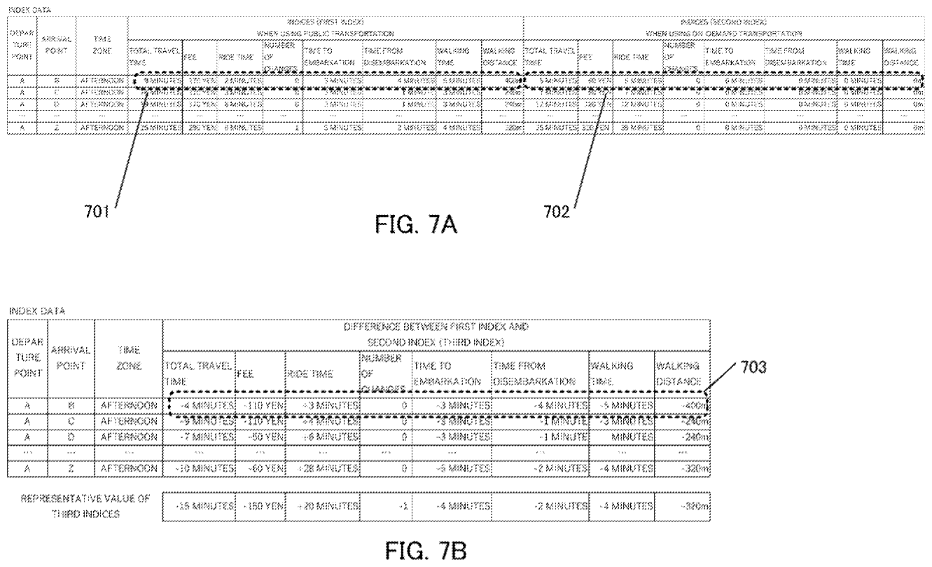

Actual examples of the calculated indices will now be described with reference to FIG. 7A. In step S123, for example, a plurality of indices (in this example, the total travel time, the fee, the ride time, the number of changes, the time to embarkation, the time from disembarkation, the walking time, and the walking distance) are calculated in relation to a pair including a certain departure point and a certain arrival point for each of a case in which only public transportation is used and a case in which only on-demand transportation is used. Here, it is assumed that the indices are calculated in relation to travel from zone A to zone B. A reference numeral 701 indicates the first index, and a reference numeral 702 indicates the second index.

Note that in this embodiment, the departure and arrival points and the stations of the mobility service are assumed to be located in the center points of the zones, but the present invention is not limited thereto, and instead, for example, the departure and arrival points may be located in random positions within the zones. The stations may likewise be installed in random positions within the zones. Further, when candidate station locations already exist, it may be assumed that stations are located in the candidate locations.

Moreover, to simplify the description, it is assumed here that twenty-six zones A to Z are included in the subject area. Furthermore, it is assumed in the following description that the terms first index, second index, and third index each denote a group of a plurality of indices, as illustrated by the dotted lines in FIGS. 7A and 7B.

Next, in step S124, a determination is made as to whether or not all arrival points have been selected, and when all arrival points have not been selected, an unselected zone is selected anew as the arrival point. Thus, the first index and the second index are calculated for cases in which zone A is set as the departure point and all of the other zones (B to Z) are set as the arrival point. In other words, the table shown in FIG. 7A is completed.

In step S125, once all arrival points have been selected, a third index is calculated for the zone serving as the departure point. The third index is the difference between the first index and the second index. A reference numeral 703 indicates the third index. Thus, as shown in FIG. 7B, differences between the indices in cases where travel is performed from a certain zone to the other zones are acquired. In this example, twenty-five groups of third indices are acquired for cases in which the zones B to Z are set as the arrival point.

Next, in step S126, a representative value of the plurality of acquired third indices is acquired for each index type. In this embodiment, an average value of the total travel time, an average value of the fee, an average value of the ride time, and so on are acquired. As a result, values representing the advantageousness of on-demand transportation over public transportation can be acquired for cases in which travel is performed from a certain zone (in this example, zone A) to the other zones.

Note that in this embodiment, the average value is used as the representative value, but a different value may be used as the representative value. For example, the median, the mode, or another value may be used.

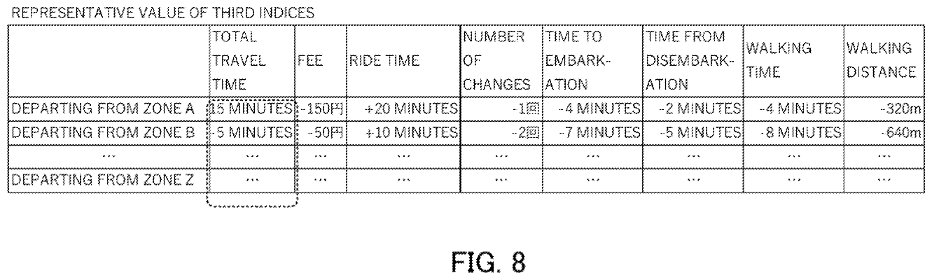

In step S127, a determination is made as to whether or not all departure points have been selected, and when all departure points have not been selected, an unselected zone is selected anew as the departure point. Thus, as shown in FIG. 8, representative values of the third index can be acquired for all of the zones.

Step S12 is then terminated.

In step S13, suitable zones for setting stations are extracted from the subject are on the basis of the calculation results acquired by the index calculation unit 22.

An extraction method based on a single index may be employed as one extraction method. For example, zones in which the reduction in the total travel time satisfies a reference may be extracted as station setting candidates.

In this case, when the average value of the reduction in the total travel time (the average value in the dotted line in FIG. 8) is minus 25 minutes, for example, zones in which the reduction in the total travel time equals or exceeds 25 minutes are extracted (extraction method A hereafter).

An extraction method based on a combination of a plurality of indices may be used as another extraction method. For example, zones in which “the reduction in the total travel time equals or exceeds 25 minutes” and “the reduction in the walking distance equals or exceeds the average value (350 m, for example)” may be extracted as station setting candidates (extraction method B hereafter).

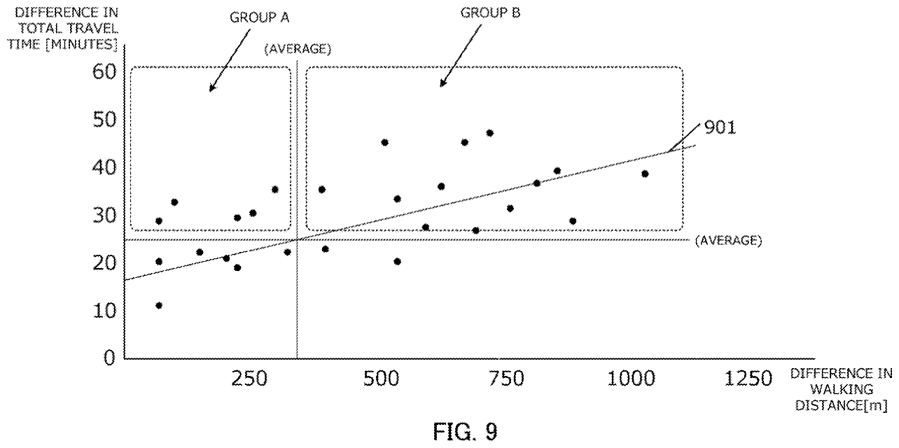

FIG. 9 shows the example described above. FIG. 9 is a view plotting the improvement in the indices when a station is installed in a certain zone using two indices, namely the “total travel time” and the “walking distance”. The dots in FIG. 9 correspond respectively to zones included in the subject area.

When extraction method A is used, zones included in group A and group B are extracted as the station setting candidate zones. Further, when extraction method B is used, zones included in group B are extracted as the station setting candidate zones.

Note that in this embodiment, a combination of two indices is described, but three or more indices may be combined. Moreover, the indices used to extract zones may be modified according to targets. For example, indices such as “the difference in the total travel time”, “the difference in the fee (travel cost)”, “the difference in the number of changes”, and “the difference in the walking time (walking distance)” and combinations thereof can be used as desired.

Furthermore, the extraction of step S13 may be performed using a model formula. For example, regression analysis may be performed on the plotting results indicated by the reference numeral 901, and the acquired model formula may be used to determine the zones to be extracted.

Finally, in step S14, the station setting candidate zones are presented to the user. For example, an image such as that shown in FIG. 3 may be generated, and the relevant zones may be marked and output. The user may also be informed of the degree to which the indices are forecast to improve or the like. For example, the zones may be marked using different methods (different hues, brightnesses, and so on, for example) depending on the improvement in the indices.

According to the first embodiment, as described above, the advantageousness of introducing on-demand transportation can be calculated for each zone using cost indices of travel.

When calculation is performed using the actual travel demand, a problem arises in that only locations where large numbers of people gather are extracted, and as a result, geographical locations that can be used to complement public transportation are not extracted. According to this embodiment, however, zones that would be improved in convenience by making on-demand transportation usable can be unearthed, and as a result, overall travel can be brought closer to the optimum.

Moreover, the predicted reduction in travel cost is calculated, and therefore the effects of introducing on-demand transportation can easily be estimated.

### Second Embodiment

In the first embodiment, the user is presented with all of the zones extracted in step S13. In a second embodiment, on the other hand, the plurality of zones extracted in step S13 are ranked on the basis of the previous travel records of consumers and presented thus to the user.

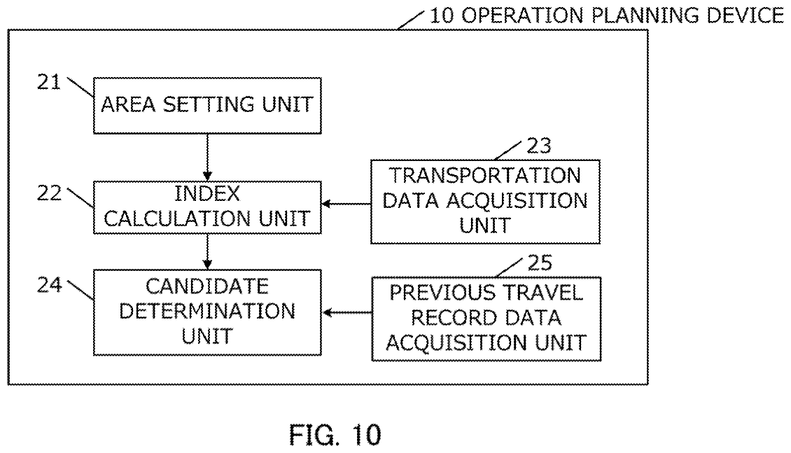

FIG. 10 shows a module configuration of the operation planning device 10 according to the second embodiment. The operation planning device 10 according to the second embodiment differs from the operation planning device 10 according to the first embodiment in being configured to include a means (a previous travel record acquisition unit 25) for acquiring the previous travel records of consumers.

The previous travel record acquisition unit 25 serves as a means for acquiring data (previous travel record data hereafter) expressing the previous travel records of consumers over a predetermined period in an O/D format. The previous travel record data are data in which numbers of people traveling from a certain zone to another zone are classified according to departure points and arrival points. The data may be generated on the basis of the results of a questionnaire issued to the consumers or information (GPS data, results of route searches, and so on) gathered from portable computers owned by the consumers. The previous travel record data may be stored in the device in advance or acquired from an external device over a network.

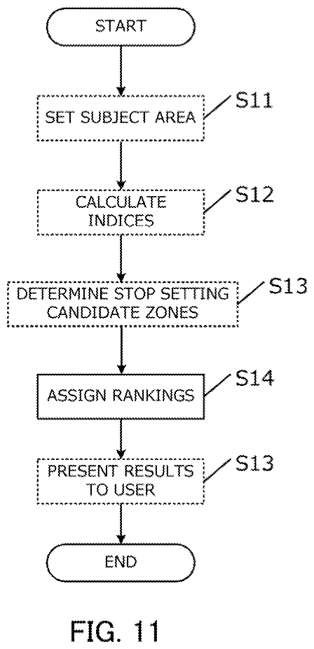

FIG. 11 is a flowchart showing a flow of the processing executed by the operation planning device 10 according to the second embodiment.

In the second embodiment, when step S13 is complete, a step (step S13A) for ranking the extracted zones is executed. In this step, the candidate determination unit 24 ranks the zones extracted in step S13 on the basis of the acquired previous travel record data.

The zones are ranked on the premise that the more previous travel records a zone includes, the more frequently the zone will be used following setting of an on-demand transportation station therein. For example, when the total number of people departing from a certain zone over the predetermined period is large, the zone is assumed to be a suitable zone for setting a station, and therefore the zone is assigned a higher ranking.

Note that the rankings may be assigned on the basis of both the number of departing people and the number of arriving people. In other words, the rankings may be assigned on the basis of the total number of departing people and the total number of arriving people.

Note that in steps S13 and S13A, the suitability of each zone as a departure point is evaluated, whereas the suitability as an arrival point is not evaluated. Accordingly, zones that are highly suitable as arrival points may also be determined. For example, it may be estimated that a zone in which a large number of people arrive from a zone having a high ranking will be highly suitable as an arrival point.

For example, after assigning the rankings in step S13A, the total number of people arriving from a zone having a high ranking may be calculated for each zone. Zones having a high total may then be determined to be zones that are suitable as arrival points, and these zones may be added as station setting candidate zones to the zones extracted in step S13. According to this configuration, setting candidate zones can be determined in consideration of a combination of the departure point and the arrival point.

Note that in the second embodiment, the rankings are assigned on the basis of the previous travel record data alone, but the rankings may be assigned using another reference. For example, zones in which the improvements in the cost indices are high may be assigned a higher ranking. Also note that the cost indices used to extract zones in step S13 do not have to be the same as the cost indices used to assign rankings in step S13A.

Further, in the second embodiment, the zones may be marked according to the ranking when outputting the results in step S14. For example, a zone having a high ranking may be displayed in a hue of a warmer color or in a darker color. Alternatively, zones having a high ranking may be displayed more brightly.

### Third Embodiment

In the second embodiment, rankings are assigned in step S13A on the basis of the previous travel records alone. In a third embodiment, on the other hand, rankings are assigned using a plurality of different references, including the previous travel records. The operation planning device 10 according to the third embodiment is configured identically to that of the second embodiment. Hence, detailed description of the modules thereof has been omitted, and only differences in the processing will be described.

In the third embodiment, the zones are classified into a plurality of groups in step S13 on the basis of predetermined references. For example, in the example shown in FIG. 9, the zones are classified into a “group in which the difference in the total travel time is greater than the average value and the difference in the walking distance is smaller than the average value (group A)” and a “group in which the difference in the total travel time is greater than the average value and the difference in the walking distance is greater than the average value (group B)”.

Then, in step S13A, rankings are assigned using a different reference for each group. The following references, for example, may be used.

(1) In group A, the differences in the total travel time are not widely distributed, and therefore zones in which the number of changes is reduced to a greater extent are assigned higher rankings.

(2) In group B, demand is likely to be distributed, and therefore zones including larger numbers of previous travel records are assigned higher rankings.

Hence, in the third embodiment, the plurality of zones are classified into a plurality of groups on the basis of a plurality of third indices, and rankings are assigned using a different reference for each classified group. According to this configuration, appropriate rankings can be assigned in accordance with different viewpoints.

Note that in this example, the groups are generated according to two items, namely “the difference in the total travel time” and “the difference in the walking distance”, but three or more items may be used. Further, the method of generating the groups is not limited to a specific method. For example, the groups may be divided using results of regression analysis, as indicated by the reference numeral 901. The method of dividing the groups and the references used to assign the rankings may be set as appropriate according to targets.

### Modified Examples

The embodiments described above are merely examples, and the present invention may be modified as appropriate within a scope that does not depart from the spirit thereof.

For example, in the description of the embodiments, only the flow shown in FIG. 5 was cited as an example, but instead, calculation results may be stored once and then called up. Further, results can be generated in a plurality of patterns while modifying parameters (for example, the cost indices used in step S12, the cost indices used to extract zones in step S13, the cost indices used to assign rankings in step S13A, and so on), and the generated results can be compared.

What is claimed is:

1. An information processing method for determining candidate locations for setting an embarkation/disembarkation point of a second transportation mode that is operatable on-demand, using as a subject an area in which a first transportation mode having a managed operation schedule and the second transportation mode are both available, the method comprising:
a division step for dividing the subject area into a plurality of unit zones;
a calculation step for calculating, for each of the plurality of unit zones, a first index, which is a cost index of a case in which travel is performed using the first transportation mode, a second index, which is a cost index of a case in which travel is performed using the second transportation mode, and a third index, which is a difference between the first index and the second index, the travel being performed using the unit zone as a start point; and
an extraction step for extracting unit zones constituting candidates for setting an embarkation/disembarkation point of the second transportation mode from the plurality of unit zones on the basis of the third index calculated for each of the plurality of zones.

2. The information processing method according to claim 1, wherein
the first index and the second index are each constituted by a representative value of a plurality of cost indices of cases in which travel is performed from a subject unit zone to each of the remaining plurality of unit zones.

3. The information processing method according to claim 1, wherein
in the extraction step, the unit zones constituting the candidates for setting an embarkation/disembarkation point of the second transportation mode are extracted from unit zones in which the third index satisfies a predetermined condition.

4. The information processing method according to claim 1, wherein
in the calculation step, a plurality of third indices are calculated for each unit zone using different cost indices, and
in the extraction step, the unit zones constituting the candidates for setting an embarkation/disembarkation point of the second transportation mode are extracted from unit zones in which the plurality of third indices satisfy predetermined conditions.

5. The information processing method according to claim 4, further comprising:
a travel demand acquisition step for acquiring a travel demand between the unit zones, and
an assigning step for assigning rankings to the extracted unit zones on the basis of the travel demand.

6. The information processing method according to claim 5, wherein
in the assigning step, the plurality of unit zones are classified into a plurality of groups on the basis of the plurality of third indices, and the rankings are assigned to each of the groups.

7. The information processing method according to claim 6, wherein
in the assigning step, the rankings are assigned using a different reference for each group.

8. A non-transitory computer readable storing medium recording a computer program for causing a computer to perform the information processing method according to claim 1.

9. An information processing device for determining candidate locations for setting an embarkation/disembarkation point of a second transportation mode that is operatable on-demand, using as a subject an area in which a first transportation mode having a managed operation schedule and the second transportation mode are both available, the device comprising:
a divider configured to divide the subject area into a plurality of unit zones;
a calculator configured to calculate, for each of the plurality of unit zones, a first index which is a cost index of a case in which travel is performed using the first transportation mode, a second index which is a cost index of a case in which travel is performed using the second transportation mode, and a third index which is a difference between the first index and the second index, the travel being performed using the unit zone as a start point; and
an extractor configured to extract unit zones constituting candidates for setting an embarkation/disembarkation point of the second transportation mode from the plurality of unit zones on the basis of the third index calculated for each of the plurality of zones.
